(19) United States
(12) Patent Application Publication
(10) Pub. No.: US 2005/0163972 A1
(43) Pub. Date: Jul. 28, 2005

(54) Thermally formed animal mats

(76) Inventor: Patrick Roy Mooney, Dartry (IE)

Correspondence Address: John R Flanagan, P O Box 2629, Eugene, OR, 97402, US

(21) Appl. No.: 10/512,503

(22) PCT Filed: Apr. 25, 2003
(86) PCT No.: PCT/IE03/00060

(30) Foreign Application Priority Data
Apr. 25, 2002 (IE) S2002/0301

(51) Int. Cl. B32B 3/02

(52) U.S. Cl. 428/157

(57) ABSTRACT

Animal mat (1) comprises an inner section (3) and thermally formed edges (2) and faces (4). A connector (6) is used to secure neighbouring like mats (1) together. Connector (6) comprises a strong flexible material twice folded on itself to form two interior sections (7a, 7b) to secure the edges (2) of two neighbouring mats (1).

The present invention relates to animal mats and to a method of thermally forming animal mats, and connecting such mats together. These mats may be used by bovines, horses, dogs and other animals.

Mats are known which are placed underneath animals as insulation against the cold and as a substitute for bedding such as straw which is labour intensive.

There is a problem with joining or connecting such mats together to prevent the mats being separated and damaged by animals while in use. Also, if the mats are separated dirt may get under the mats. There is also a problem with expansion of such mats due to heat.

The present invention seeks to overcome the above described disadvantages.

Accordingly, the present invention provides an animal mat having thermally formed edges and a connecting device or connector for securing the thermally formed edges of neighbouring mats together.

Conveniently, the edges or an outer section or sections of the mat are compressed to bring them to the required shape and thickness. Compression of the mat is achieved using a pressurised mould with cold or refrigerated plates after the mat has been heated so it is nearly molten. This ensures that the mat retains its thermally formed shape as it has been given a new structural memory so that it will not return to its original shape after removal from the mould. Advantageously the cold or refrigerated plates and nearly molten mat enable compression of the mat to occur at a relatively low pressure.

Preferably, the compressed outer section or sections of the mat include gripping elements for attachment to a connector. The connector also may contain gripping elements for attaching to neighbouring mats. The connector serves to secure neighbouring mats together.

In a convenient arrangement, the connector comprises a long piece of flexible, ideally strong material, which may be folded back and forth across its width to create interior sections for housing the outer sections of mats.

The invention will hereinafter be more particularly described with reference to the accompanying drawings, which illustrate by way of example only, embodiments of a mat and a connector according to the invention. In the drawings:

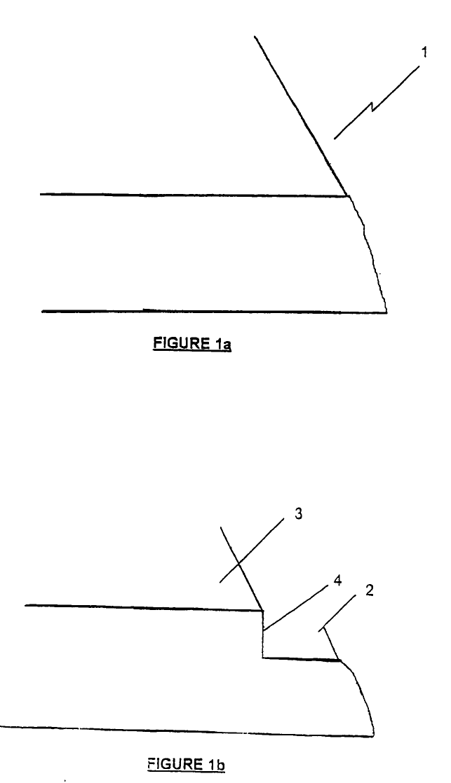

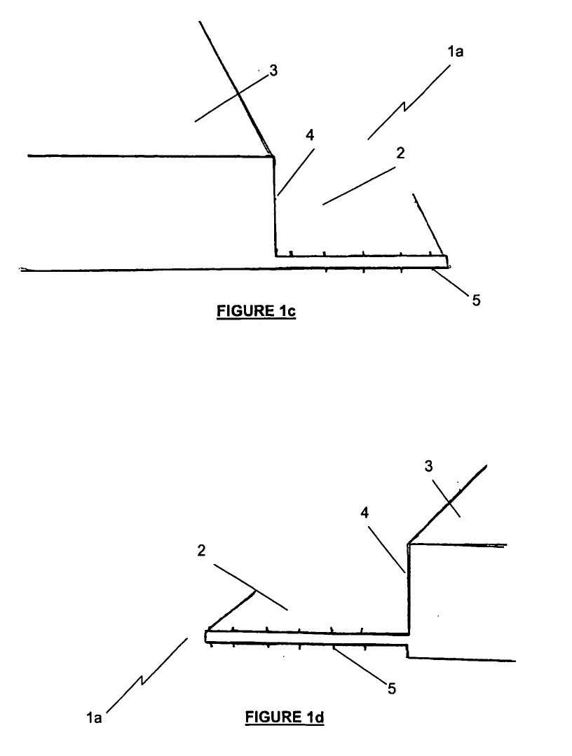

FIG. 1a is a perspective view of a corner detail of an animal mat as it leaves a hot mould or after it has been reheated;

FIG. 1b is a perspective view of the animal mat of FIG. 1a in the process of being thermally formed;

FIG. 1c is a perspective view of the animal mat of FIG. 1a where an outer section has been thermally formed to the shape and thickness required;

FIG. 1d is a perspective view of the animal mat of FIG. 1a where one side has been thermally formed so that the outer section is raised from ground level;

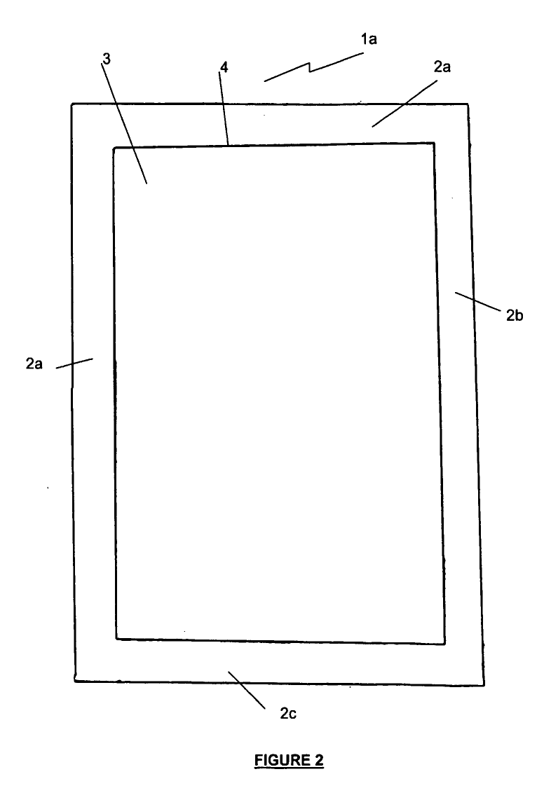

FIG. 2 is a plan view of the animal mat of FIG. 1c where outer sections have been thermally formed; and

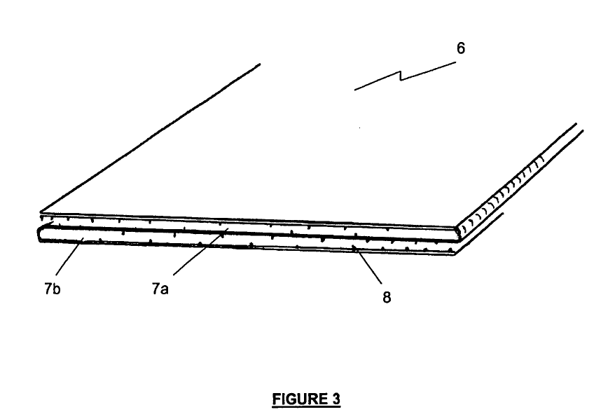

FIG. 3 is a perspective view of a connector used to join two thermally formed mats of the invention.

Referring now to the drawings, animal mat 1 as shown in FIG. 1a, has just left a hot mould or has just been reheated. FIG. 1b shows a section of the animal mat 1 in the process of being thermally formed. An outer edge 2 of the nearly molten animal mat 1 is being pressed by a mould with cold or refrigerated plates (not shown) under pressure. The shape and thickness of the outer edge 2 is not yet the shape and thickness required. Inner section 3 is not thermally formed and remains at the original thickness of the animal mat 1.

A face 4 is formed between the inner section 3 and edge 2. If required however, inner section 3 or a portion thereof may be thermally formed.

FIG. 1c shows a section of the thermally formed animal mat 1a which has been successfully thermally formed so that the inner section 3, the face 4, and the edge 2 are the shape and thickness required. The inner section 3 has the original thickness of the mat 1 as it has been thermally formed. However, the inner section 3 may be cold moulded to have a slight incline for example from the centre to the sides to allow for such features as drainage slopes, a logo, or patterns. The thermally formed edge 2 has been pressed by a cold mould under pressure to the shape and thickness required. The outer section 2 contains grips 5. As the edge 2 has been compressed, it is now harder and stronger and may be used to aid the attachment of the thermally formed mat 1a to neighbouring mats. The face 4 is created due to the difference in thickness of inner section 3 and the edge 2 caused by the cold moulding of the edge 2. The face 4 is a smooth straight surface perpendicular to the edge 2 and the inner section 3.

FIG. 1d shows a section of a animal mat 1a which has been thermally formed to provide an edge 22. In this case the edge 22 is raised from ground level by an amount sufficient to allow the edge 2 of another mat fit snugly underneath so that the two edges are joined in a connecting device. The edge 22 also contains grips 5 which can be protrusions or ridges.

FIG. 2 shows a plan view of thermally formed animal mat 1a where edges 2a, 2b, 2c, 2d of the four sided mat 1 have been thermally formed. Conveniently, each of the four edges 2a, 2b, 2c, 2d has been thermally formed at the same time.

Referring now to FIG. 3, a connector 6 is used for securing neighbouring thermally formed mats 1a together. The connector 6 comprises a strong flexible material, for example aluminium, or stainless steel. The connector 6 is approximately twice the width of the thermally formed edge 2 of a mat 1a and is relatively small in thickness with respect to the edge 2 of mat 1a. The connector 6 is twice folded over on itself. This serves to create two equal sized interior sections 7a, 7b formed by being one above the other which are dimensioned to receive the edges 2 of two neighbouring mats 1a from the right and left of the connector 6 respectively. Interior sections 7a, 7b contain grips 8, which together with the grips 5 on the edges 2 of the mats 1a, ensure the edges 2 of the mats 1a are firmly secured to the interior sections 7a, 7b of the connector 6.

In use, the connector 6 is dimensioned so that insertion of the edge 2 of a mat 1a is easily achieved. The connector 6 is flexible so that each interior section 7a, 7b may be easily expanded by a user to allow an edge 2 of a mat 1a be placed inside without difficulty.

Similarly, the extraction of an edge 2 of a mat 1a may be assisted by this feature of opening or enlarging the interior sections 7a, 7b. However, once the connector 6 is attached to the edge 2 of a thermally formed mat 1a via grips 5, 8 the surfaces are secured together so they will not be dislodged by animals while in use. This ensures that the mats remain in their intended place and dirt does not get under the mats.

The connector 6 is constructed so that either of the interior sections 7a, 7b may be used first, i.e. an edge 2 of a mat 1a may be inserted or extracted first from either interior section 7a, 7b. Also the connector 6 has the advantage that edges 2 of mats 1a may be inserted or extracted from the connector 6 at the same time.

Referring again to FIG. 2, each of the four edges 2a, 2b, 2c, 2d may be secured via a connector 6 to a neighbouring mat so that the mat 1a shown in FIG. 2 is secured to four other identical mats 1a. In this way, a large floor area can be covered by a succession of connected mats.

As an alternative to a four sided rectangular shaped mat, the mats may be formed in any shape required which allows for attachment to neighbouring mats via connectors, for example three sided triangular, six sided hexagonal. The mats in use may not be identical, once they connect together and ideally leave no gaps.

Suitable materials for constructing the mats will suggest themselves to the skilled person, including rubber and metallic or other polymeric elastomeric material.

The grips between the outer sections of the thermally formed mats and the connectors may be formed by any suitable means of providing a strong connecting pressure, for example steel pins, rubber or plastic projections, or glue. To assist the gripping, small holes may be provided in the outer sections of the mats and the connectors for the pins or projections to connect on to.

It is to be understood that the invention is not limited to the specific details described herein, which are given by way of example only, and that various modifications and alternations are possible without departing from the scope of the invention as defined in the appended claims 1 to 10 which are incorporated herein by reference.

1. An animal mat having thermally formed edges.

2. An animal mat as claimed in claim 1, in which the thermally formed edges are compressed in thickness relative to the remainder of the mat.

3. An animal mat as claimed in claim 1, in which one or more of the thermally formed edges is formed at a different level to other edges so as to allow overlap of the different level edges of neighbouring mats.

4. A connecting device or connector for securing the thermally formed edges of neighbouring like animal mats as claimed in claim 1.

5. A connecting device or connector as claimed in claim 4, in which the connector comprises two overlapping sections for gripping two contiguous edges of neighbouring mats.

6. An animal mat as claimed in claims 1, and a connecting device for securing the thermally formed edges of neighbouring like animal mats, in which the connecting device comprises two overlapping sections for gripping two contiguous edges of neighbouring mats and in which thermally formed edges include gripping elements for engagement with the connecting device and optionally the connecting device includes complementary engageable formations.

7. An animal mat and connecting device as claimed in claim 6, in which the edges of the mat and the connecting device have complementary engageable formations.

8. A method of forming an animal mat, the method comprising:
forming a mat by compression moulding; and
thermally forming an edge or edges of the mat by compressing the edge or edges of the mat to the required shape or thickness, using a pressurized mould with cold or refrigerated plates while the mat is close to its melting temperature, so as to ensure that the edge or edges retain the thermally formed shape.

9. (canceled)

10. (canceled)

11. An animal mat as claimed in claim 2, in which one or more of the thermally formed edges is formed at a different level to other edges so as to allow overlap of the different level edges of neighbouring mats.

12. A connecting device or connector for securing the thermally formed edges of neighbouring like animal mats as claimed in claim 2.

13. A connecting device or connector for securing the thermally formed edges of neighbouring like animal mats as claimed in claim 3.

14. An animal mat as claimed in claim 2, and a connecting device for securing the thermally formed edges of neighbouring like animal mats, in which the connecting device comprises two overlapping sections for gripping two contiguous edges of neighbouring mats and in which the thermally formed edges include gripping elements for engagement with the connecting device and optionally the connecting device includes complementary engageable formations.

15. An animal mat and connecting device as claimed in claim 14, in which the edges of the mat and the connecting device have complementary engageable formations.

16. An animal mat as claimed in claim 3, and a connecting device for securing the thermally formed edges of neighbouring like animal mats, in which the connecting device comprises two overlapping sections for gripping two contiguous edges of neighbouring mats and in which the thermally formed edges include gripping elements for engagement with the connecting device and optionally the connecting device includes complementary engageable formations.

17. An animal mat and connecting device as claimed in claim 16, in which the edges of the mat and the connecting device have complementary engageable formations.
